(19) United States
(12) Patent Application Publication
(10) Pub. No.: US 2004/0122694 A1
(43) Pub. Date: Jun. 24, 2004

(54) Method for financing automotive repair equipment

(76) Inventor: Ryan Foucault, Spokane, WA (US)

Correspondence Address: Ryan Foucault, 6422 East 17th Ave., Spokane, WA, 99212, US

(21) Appl. No.: 10/659,071

(22) Filed: Sep. 10, 2003

Related U.S. Application Data
(60) Provisional application No. 60/409,743, filed on Sep. 10, 2002.

(51) Int. Cl. G06F 17/60

(52) U.S. Cl. 705/1

(57) ABSTRACT

In accordance with the present invention, there is provided a method of financing a piece of automotive equipment on a pay per use basis. Through the use of a control device mounted either externally or internally to a piece of automotive equipment and communications to a remote computer system the piece of automotive equipment can be monitored for usage or serviceability. The control device also provides a method of shutting down a piece of automotive equipment due to lack of payment or with the Global Positioning System track the piece of automotive equipment if it has moved from the position of record.

### CROSS-REFERENCE TO RELATED APPLICATIONS

This application claims the benefit of PPA Ser. No. 60/409,743

FEDERALLY SPONSORED RESEARCHNot Applicable SEQUENCE LISTING OR PROGRAM

Not Applicable

### BACKGROUND OF THE INVENTION

1. Field of the Invention

The present invention relates generally to a method of financing or renting a piece of automotive repair equipment on a per use basis. More particularly to a method for monitoring a piece of equipment wirelessly and determining the amount of uses in a given time period.

2. Background of the Invention

Generally automotive repair equipment such as lifts, brake lathes, fuel system cleaners etc. have been financed through a loan system such as a lending institution where the institution pays for the equipment and takes title to the equipment then bills the customer for a certain length of time. At the end of the contract period the customer either owns the equipment or in the case of a lease the customer sends an amount that the contract specifies, then is given title to the equipment.

### OBJECTS AND ADVANTAGES

Accordingly, several of my invention's objects and advantages are:

(a.) to provide a means for automotive repair shops to utilize and possibly own a piece of automotive repair equipment in a way that conforms better to their actual usage of the equipment.

(b.) to provide a means of monitoring a piece of automotive equipment with any type of communication method whether wireless or landline based.

(c.) to provide a means of greater protection to a financial institution with the ability to disable a piece of automotive equipment from being used due to lack of payment.

(d.) to provide a means of tracking a piece of automotive equipment when the automotive equipment has moved from the position of record at the financial institution.

(e.) to provide a means of monitoring a piece of automotive repair equipment regardless of whether it is microprocessor controlled or not.

### SUMMARY OF THE INVENTION

Breifly stated an embodiment of the present invention is that a piece of automotive repair equipment can be financed on a per use basis and remotely monitored for that usage. The present invention also allows the lender to either disable the automotive repair equipment due to lack of payment or track the equipment for repossession.

### BRIEF DESCRIPTION OF THE DRAWINGS

These as well as other aspects of the current invention will become more apparent upon reference to the drawings wherein:

FIG. 1 symbolically depicts a automotive repair equipment remote monitoring system configured to utilize the preferred embodiment of the current invention; and

FIG. 2 is a flow diagram of the steps of the method of the current invention.

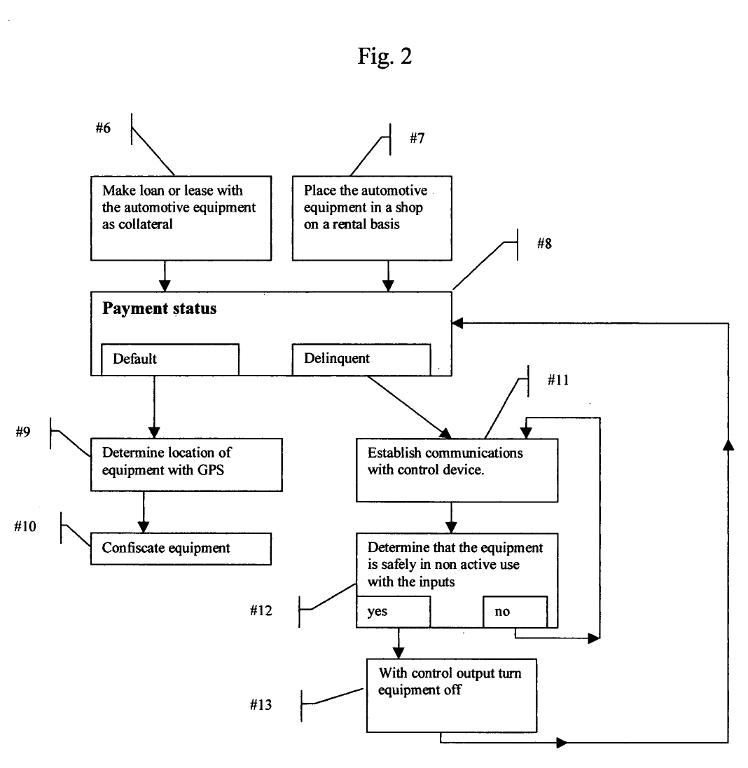

FIG. 3 is a flow diagram of the steps of the method of the current invention.

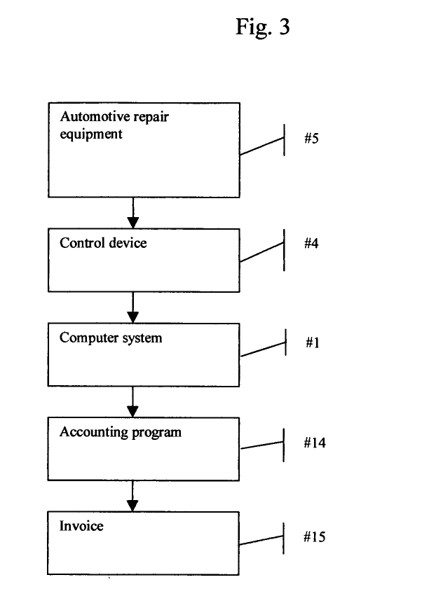

### DETAILED DISCRIPTION OF THE PREFERRED EMBODIMENT

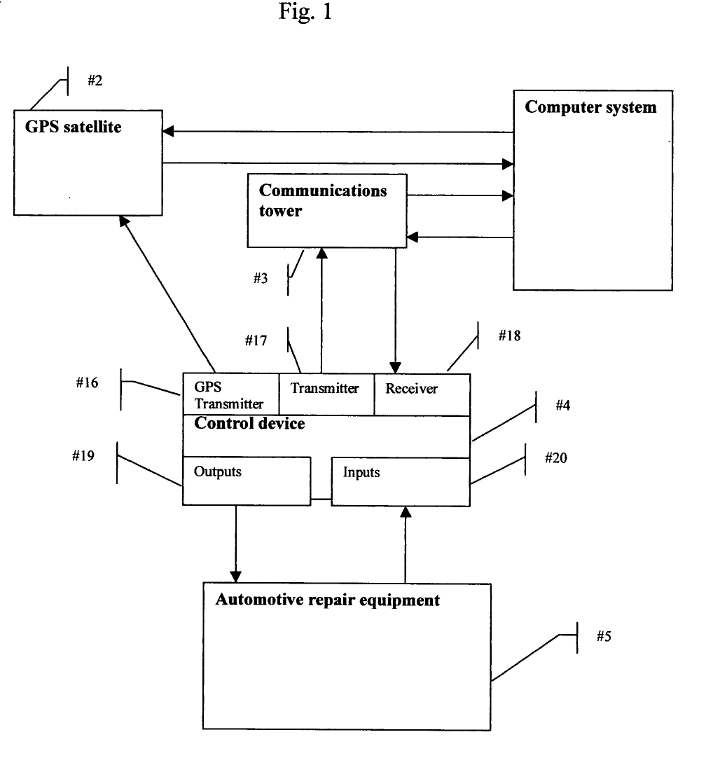

Referring now to the drawings wherein the showings are for the purposes of illustrating a preferred embodiment of the current invention only, and not for the purposes of limiting the same, FIGS. 1,2 and 3 illustrate a method of financing automotive repair equipment in accordance with the current invention.

As a preliminary matter, it is assumed that a lending institution makes a loan/lease arrangement 6 or a rental agreement 7 with a borrower or renter respecting a piece of automotive repair equipment 5. Whether the equipment 5 is purchased, leased or rented the securing party may be a bank, savings and loan, mortgage company, credit union, equipment manufacturer, leasing agent, collection agency, or any other financial or lending institution and agents thereof. It is further understood that the holder or possessor of the equipment may be the party responsible for payment of the equipment loan, lease or rental. For the purposes of this current invention the term equipment 5 is contemplated to include engine analyzers, wheel aligners, emissions test equipment, brake lathes, wheel balancers, tire changers, air conditioning equipment, fluid management devices, vehicle lifts or hoists, dynamometers, machine shop equipment, collision racks, paint booths and other such devices or equipment used for the repair of automobiles or trucks.

Before or after the equipment 5 is placed with the customer the method provides for the placement of a control device 4 either internally or externally mounted on equipment 5 or integrated into equipment's 5 workings itself. In the preferred embodiment the control device 4 monitors equipment 5 and keeps track of the amount of uses, the control device 5 then sends that information wirelessly through 3 a communication tower 5 to a computer station 1. After 1 computer station 1 receives the information it processes it through an accounting system 14 or other program to determine the amount to be billed to the customer according to the amount of uses of equipment 5 times the rate per usage.

At that time an invoice 15 is generated and sent to the customer.

In the preferred embodiment of the current invention, a control device 4, which can be purchased from remote monitoring companies such as Telemetric of 9941 West Emerald Street Boise, Id. 83704, is installed on equipment 5. The control device 4 is provided with an input device 20 that is able to monitor voltage, amperage and frequency from multiple sources for example on a wheel balancer the input device 20 would be hooked up through an electrical wire to the power input cable of the motor that powers the wheel balancing shaft. When power is supplied to the motor the input device 20 would see the voltage and count that as one usage. An input device 20 is an internal or externally mounted part of a control device 4. A control device 4 can be any type of analog or digital processing device, or a computer, such as microprocessor. The use of a computer or microprocessor as the control device 4 allows flexibility in the programming such as the ability to program preset values that cause the a control device 4 to communicate through a transmitter 17, a receiver 18 or an output device 19. When a control device 4 senses a electrical signal outside of its preset values, reaches a predetermined time or is queried remotely for information or asked to perform an action through a receiver 18 it sends the requested information through a transmitter 17. A transmitter 17 may take the form of a cellular or other wireless communications device. It is further contemplated that a transmitter 17 and a receiver 18 may be the same device capable of sending and receiving information. After being requested to send the information a transmitter 17 sends the information through a communications tower 3 to a computer device 1. In the preferred embodiment the communications tower 3 is a cellular system however it could also be 802.11a, 802.11b, radio, Bluetooth or other wireless communications system. The computer device 1 could be a PC, server, laptop, or handheld computer.

In addition, the method of the current invention provides for a system for shutting the equipment 5 down in the case of a change in payment status 8 of either default or delinquent. With the case of a delinquent payment status 8 a computer device 1 establishes communication with the control device 4 through the communications tower 3. After establishing communications a computer device 1 sends a command through the communications tower 3 to the receiver asking 18 it if it is in operation 12. If the answer is no it notifies output device 19 to turn the equipment off 5 through the use of an electrical switch or other such device. If the answer is yes the computer device 1 continues to query the control device 4 until it is safely out of operation. When payment status 8 has changed to a non delinquent or default condition the situation is reversed and the equipment is turned back on. In the case of a delinquent payment status 8 the use of a global positioning satellite system 2 is used to determine the location of the equipment. As one experienced with the art will appreciate locating equipment 5 is derivable from the GPS transmitter 16. With this information we can then confiscate 10 the equipment.

### CONCLUSION, RAMIFICATIONS, AND SCOPE

Accordingly, the reader will see that the financing system of the present invention provides an ability for Financial institutions, and Automotive equipment owners to lower the risk of typical ownership by paying for the equipment when it is used and having the ability to disable the unit for lack of payment or track the unit for repossession. While my above description contains many specificities, these should not be construed as limitations on the scope of the invention, but rather as an exemplification of one preferred embodiment thereof. Many other variations are possible. For example with the present invention you could install the control unit and communications system to only monitor the components of the automotive repair equipment for service problems such as a motor failing etc. Thus the scope of the invention should be determined not by the embodiment(s) illustrated, but by the appended claims and their legal equivalents.

1. A method of financing on a per use basis automotive repair equipment comprising:
(a) a remote monitoring device capable of measuring with inputs the number of times or the amount of time a device or devices on the automotive repair equipment is used
(b) where the remote monitoring device in (b) is capable of communication with a remote site
(c) a piece of automotive repair equipment
